(19) United States
(12) Patent Application Publication
(10) Pub. No.: US 2003/0005426 A1
(43) Pub. Date: Jan. 2, 2003

(54) Methods and apparatus for upgrading software without affecting system service

(76) Inventors: Dale A. Scholtens, Lisle, IL (US); Robert Roden, Ennis (IE); Donal Cooney, Ardnacrusha (IE); Barry J. Glicklich, Warrenville, IL (US); Walter Slotarski, Palatine, IL (US); Wesley R. Decker, Naperville, IL (US); Kevin M. Cramer, Parker, CO (US)

Correspondence Address: Kenneth J. Rudofski, Tellabs Operations, Inc., 1415 West Diehl Road, MS 16, Naperville, IL, 60563, US

(21) Appl. No.: 10/166,148

(22) Filed: Jun. 7, 2002

Related U.S. Application Data
(60) Provisional application No. 60/297,217, filed on Jun. 8, 2001.

(51) Int. Cl. G06F 9/44

(52) U.S. Cl. 717/169

(57) ABSTRACT

A method for managing an upgrade on a system that includes a system manager, a subsystem of a first type and a subsystem of a second type that is subordinate to the subsystem of the first type is disclosed.

### RELATED APPLICATIONS

This patent application claims priority to the provisional patent application having the assigned serial No. 60/297,217 filed on Jun. 8, 2001 and entitled METHODS AND APPARATUS FOR UPGRADING SOFTWARE WITHOUT AFFECTING SYSTEM SERVICE.

### FIELD OF THE INVENTION

The present invention relates to procedures for upgrading software in a system. More specifically, the present invention relates to a method and apparatus for upgrading software in a system having heterogeneous integrated subsystems.

### BACKGROUND OF THE INVENTION

Software upgrades are often provided to systems to correct software bugs or to introduce new features and capabilities. In order to achieve this, the software upgrade is installed on the system and the system is restarted. In mission critical systems such as telecommunication systems, it is highly desirable, and arguably necessary, to preserve flows of information (e.g., voice calls) present as a system is upgraded. It is similarly necessary to accommodate ongoing demand for services (e.g., new calls) during upgrade. Two elements are critical to upgrading without service interruption: First, it must be possible to gracefully control a system, assuring that its component subsystems are upgraded in an orderly fashion. Second, it must be possible to dynamically accommodate the changes in data schema between old and new versions of software.

Approaches in the past for upgrading systems addressed various types of subsystems within the systems individually. However, as systems have expanded, the number of subsystems that typically make up a system has also increased. With the increased number of subsystems in a system, addressing subsystems individually becomes more difficult. The likelihood of errors resulting in loss of service increases, which is undesirable.

### SUMMARY OF THE INVENTION

According to an embodiment of the present invention, a method for managing upgrade steps on a system that includes a subsystem of a first type and a subsystem of a second type that is subordinate to the subsystem of the first type includes initiating an upgrade step on the subsystem of the first type and initiating the upgrade step on the subsystem of the second type after completion of the upgrade step on the subsystem of the first type.

According to an embodiment of the present invention, a method for reverting to a prior software after an upgrade to a new software on a system that includes a subsystem of a first type and a subsystem of a second type that is subordinate to the subsystem of the first type includes initiating a reversion on the subsystem of the second type and initiating the reversion on the subsystem of the first type after completion of the reversion on the subsystem of the second type.

According to an embodiment of the present invention, a method for managing an upgrade to a new software on a subsystem that includes a first non-volatile memory store, a second non-volatile memory store, an active volatile memory store, a standby volatile memory store, active equipment, standby equipment includes upgrading the standby equipment to the new software, synchronizing dynamic data from the active volatile memory store to the standby volatile memory store, synchronizing dynamic data from the active volatile memory store to the first non-volatile memory store, synchronizing dynamic data from the first non-volatile memory store to the second non-volatile memory store, swapping the standby equipment with the active equipment, synchronizing dynamic data from the new active volatile memory store to the new standby volatile memory store, synchronizing dynamic data from the new active volatile memory store to the s econd non-volatile memory store, synchronizing dynamic data from the second non-volatile memory store to the first non-volatile memory store, upgrading the new standby equipment to the new software and synchronizing dynamic data from the new active volatile memory store to the new standby volatile memory store.

### DESCRIPTION OF THE DRAWINGS

The present invention is illustrated by way of example and not by way of limitation in the figures of the accompanying drawings, in which like references indicate similar elements and in which:

FIG. 1 illustrates a process diagram for an upgrade, according to an exemplary embodiment of the present invention.

FIG. 2 illustrates a subsystem memory model, according to an exemplary embodiment of the present invention.

FIG. 3 illustrates how new software is transferred onto the system, according to an exemplary embodiment of the present invention.

FIG. 4 illustrates how the system manager distributes the software to the various subsystems, according to an exemplary embodiment of the present invention.

FIG. 5 illustrates methods of tiering subsystems for upgrade and chaining subsystem upgrades within groups of subsystems, according to exemplary embodiments of the present invention

FIG. 6 illustrates the steps of Dividing, Testing, or Committing a subsystem, according to an exemplary embodiment of the present invention.

FIG. 7 illustrates Dividing a subsystem, according to an exemplary embodiment of the present invention.

FIG. 8 illustrates Testing a subsystem, according to an exemplary embodiment of the present invention.

FIG. 9 illustrates Committing a subsystem, according to an exemplary embodiment of the present invention.

FIG. 10 illustrates chaining and tiering during a commanded reversion, according to an exemplary embodiment of the present invention.

FIG. 11 illustrates chaining and tiering during an autonomous reversion, according to an exemplary embodiment of the present invention.

FIG. 12 illustrates synchronization of accounting records during an upgrade, according to an exemplary embodiment of the present invention.

### DETAILED DESCRIPTION

In an exemplary embodiment of the present invention, a system manager is a server that acts in an executive capacity to orchestrate upgrade of the subsystems it manages. The process of upgrade may be initiated by a privileged user of the system manager. The system manager is upgraded first and the subsystems are upgraded second. To simplify administration of upgrades yet minimize complexity associated with changes to protocols operating at subsystem interfaces, subsystems can be upgraded in groups. For example, subsystems of a particular type can be upgraded together as a group.

In an exemplary embodiment of the present invention, upgrade of any subsystem or group of subsystems follows a set of states. Three major states of a subsystem during an upgrade are Divided, Testing, and Committing. A subsystem is in the Divided state when the subsystem is actively operating with its old software, but is fully prepared to begin executing its new software when commanded. A subsystem is in the Testing state when its equipment is running the new software. A subsystem is in the Committing state when the subsystem is executing the sequence of operations necessary finally accept the new software.

In an exemplary embodiment of the present invention, transitions between states are ordinarily commanded by the system manager user but may occur autonomously under certain conditions. For example, in case there is a failure that impairs service or causes loss of management control over a subsystem, the failed subsystem autonomously reverts to a configuration that provides service from the originally-operating version of software, and the system manager commands any other subsystems being upgraded to revert to their originally-installed software as well. In the absence of failures, transitions between states upgrades can be hitless: new software can be installed, Tested, and either Committed to permanent use or backed-out all without loss of stable calls and without significant impairment to service. In case of a failure that seriously impairs service, reversion can occur autonomously or can be commanded. After Committing a subsystems or a cluster (a group of one or more subsystems) to use newly installed software, it can be possible to downgrade them to their former software.

In an exemplary embodiment of the present invention, system services are available throughout the upgrade process. The system preserves already-established calls/connections and handles ongoing demands for service throughout its upgrade. The subsystems rapidly switch between old and new loads without loss of pertinent dynamic data related to the system, such as for example call records, connection records, connections in hardware. Preserving dynamic data will ensure the integrity of bearer channels and permits proper accounting for services. To facilitate rapid switching, each subsystem assures dynamic resource persistence between its “old” and “new” software. This persistence is bi-directional. For example, when a subsystem is preparing to run new software, the new software has current knowledge of the state of calls/connections first handled by the old software. Similarly, once a subsystem is commanded to run with its new software, the old software is updated with the current calls/connection information in case reversion is commanded. To assure that switching between loads can be rapidly accomplished, dynamic resource persistence typically requires ongoing synchronization between the new and old copies of software while in Divided and Testing states.

In an exemplary embodiment of the present invention, the system is aware of services delivered during the course of upgrade to later charge for the service delivered. The system preserves its accounting data through and upgrade or reversion. Moreover, the system formats the data if the new software calls for a different accounting data format.

In an exemplary embodiment of the present invention, the upgrade process provides for the upgrade independent, disparate subsystems. For example, a set of subsystems associated with call/connection processing can be upgraded simultaneously. Since different subsystems will likely have different rates of progress through upgrade, the upgrade of subsystems can be chained. For example, in an upgrade involving two types of subsystems, subsystems of one type are all advanced to the Divided state before any subsystems of the second type are advanced. Chaining is executed in reverse in the case of a reversion.

In an exemplary embodiment of the present invention, the system can be highly scalable. Since the system can be very large, an operator may judge that there is significant risk associated with upgrading the entire system at once. Additionally, the logistics of a large-scale upgrade can be complex from the standpoint of assuring all equipment and facilitates are in a state amenable to upgrade. To help manage upgrades of large systems, incremental upgrade of groups of subsystems is permitted.

In an exemplary embodiment of the present invention, the system is comprised of independent subsystems, with well-defined protocols operating at inter-subsystem interfaces. As features are added to the system over time, inter-subsystem protocols may change. To assure uninterrupted service delivery in the face of protocol changes, the overall process of upgrade is tiered, with subsystems and groups of subsystems upgraded in a particular order. For example, the devices having external control and management interfaces are upgraded first and the devices having internal interfaces are upgraded second.

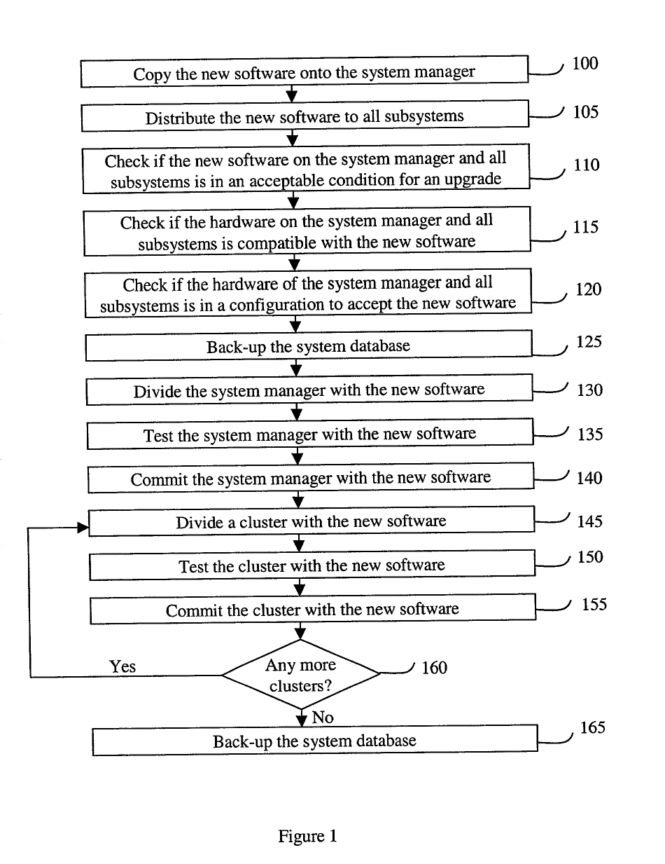

FIG. 1 illustrates a process flow diagram according to an exemplary embodiment. The system's entire software bundle is first transferred onto the system manager at step 100 and second, the appropriate software is distributed to each managed subsystem at step 105. An embodiment of the present invention can execute certain checks on the transferred and distributed software. For example, at step 110, after both transfers, the integrity of the transferred files can be checked to assure that there has been no corruption in the transfer. Further at step 115, the system checks whether newly distributed software is compatible with the hardware and software presently installed in the system. Incompatibilities can be communicated so that they can be rectified before upgrade is actually attempted. At step 120, the system can also run a configuration check after software distribution and communicate any configuration changes necessary to permit upgrade. As problems are corrected, the system manager user can re-run checks to verify problems have been cleared.

Next, the system manager is upgraded. At step 130, the system manager Divides, or prepares its new software for execution. At step 135, the system manager Tests the new software by initializing certain of its components with the new software. At step 140, the system manager Commits the new software by executing additional steps to complete the upgrade to the new software.

After the system manager user commands a cluster (a group of one or more subsystems) to upgrade, the integrity, compatibility and configuration checks are repeated in each of the subsystems in the cluster in the Divide state at step 145. If the checks pass, each subsystem in a cluster prepares its new software for execution, by for example replicating and converting its existing static configuration data to a format which is compatible with the new software at the Test state. At step 150 in the Test state, each subsystem in a cluster then initializes certain of its components with the new software and converted data, readying them for actual use. The components are placed into active operation by another command from the system manager user, and Committed to permanent use after a period of Testing in the Commit state at step 155.

The procedure suggests that database back-ups are to be performed before and after upgrade, at steps 125 and 165, with the results of each back up transferred off of the system manager for safekeeping. It is possible, though, to create a back up at any point during the upgrade process. This is desirable to limit risk when a large system is being upgraded and the overall process spans more than one maintenance window, for example, if one cluster is being upgraded per day. It this case, it may be desirable to perform a back up after each maintenance window, that is, after the system manager is upgraded, and as each successive cluster is upgraded.

### Subsystem Memory Model

To gracefully upgrade a set of heterogeneous subsystems, it is necessary to impose some uniformity on upgrade process, such as for example in a memory model for each of the subsystems. In an exemplary embodiment, all upgradeable subsystems, including the system manager, support a standard memory model. The memory model described herein is not intended to impose a particular approach on any subsystem, particularly in regard to volatile memory. At the same time, in an exemplary embodiment, subsystems align with a standard memory model to ensure that the each class of data manipulated is given appropriate and uniform treatment independent of the quantity and types of subsystems being upgraded.

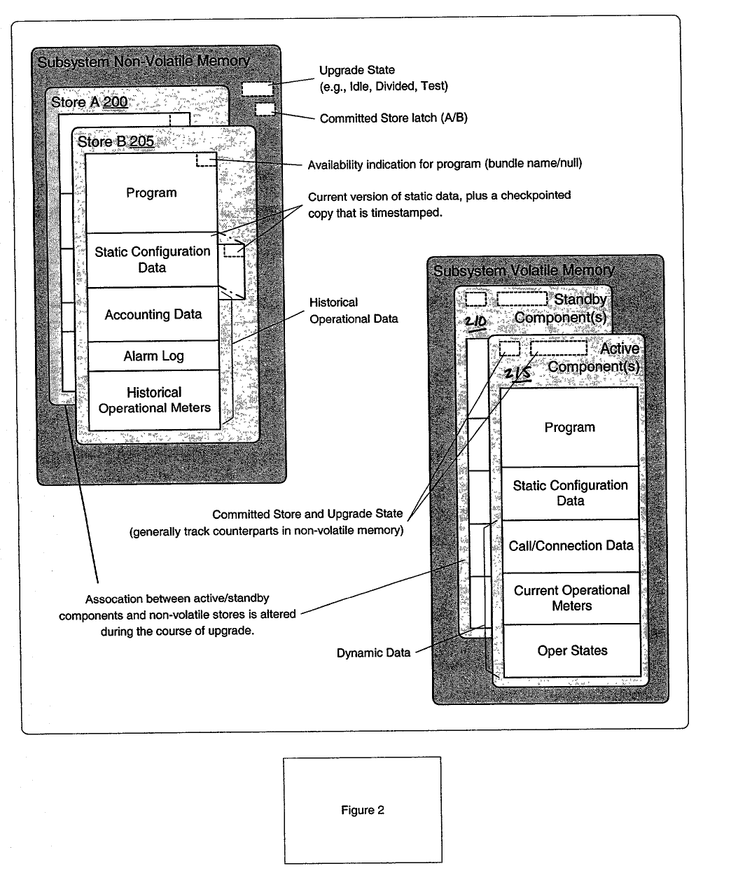

FIG. 2 illustrates a subsystem memory model for an exemplary embodiment. The model splits non-volatile memory into two areas: a first Store A 200 and a second Store B 205. It also splits volatile memory into two stores: Standby 210 and Active 215. Each non-volatile store contains a program area that holds a software version and associated data that must persist across power cycling. The data in each store have a schema and formatting compatible with that required by the particular software version, in addition to the subsystem's static configuration data and operational history. There is allowance for two copies of static configuration data reflecting the provisioning of the subsystem, one reflecting the current configuration, the other reflecting its state at a past time. There is also allowance for historical operational data of various types: accounting records (the basis for service billing), and alarm log, and historical operational meters from recently passed collection intervals.

Each volatile memory store contains a program area and associated static configuration data loaded from one of the non-volatile stores. In addition, each contains dynamic data describing for example existing calls/connections, equipment/facility operational states, and the operational meters being currently being acquired.

During normal operation, a subsystem re-initializes both of its volatile memory stores from one of the non-volatile memory stores, that store being designated by a binary “latch” which is itself maintained in non-volatile storage. The other non-volatile memory store is therefore available for use during the upgrade process. Further, a subsystem operating in its normal manner has extra components standing by to provide service in the event of failures, and switchover to these components is hitless from the standpoint of users of the equipment. Therefore, as long as upgrade is conducted at a time when there are no failures present, these standby components are available to be loaded with new software and data, and can be switched-in under manual control to effect an upgrade. The volatile memories can therefore be associated with the active and standby components of a subsystem.

The process of upgrading a subsystem, then, can broadly be thought of as first updating the unused non-volatile store with a new program and corresponding data, then loading the new program and data into the volatile memory associated with standby components. The upgrade can be tested by making the standby components active. When Committing the upgrade, the content of the unused store is marked as in-use by flipping the latch identifying the Committed store, and the other volatile memory store is loaded with the just-marked store's content. While this seems straightforward, the requisite synchronization of call/connection data to preserve service, manipulation of accounting data enable customers to be billed (or inter-carrier charges to be reconciled), and preservation of critical management information are carefully kept throughout the upgrade process.

### Transferring the New Software onto the System

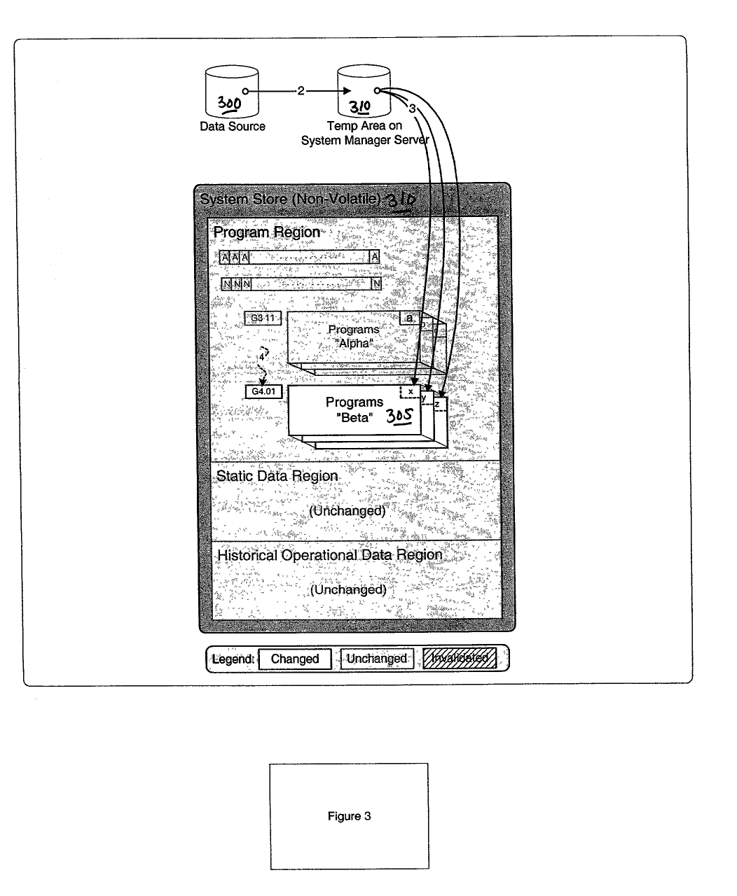

FIG. 3 illustrates how the new software is transferred onto the system in an exemplary embodiment. The system manager user using a system manager GUI places new software on the system by transferring it from a source 300, e.g., from a CD-ROM on the system manager user's workstation or direct FTP transfer from another host. The system manager user commands the transfer via the system manager GUI, identifying the source file for the transfer. The destination is, implicitly, an unused program area 305 within a non-volatile memory store 310 on the system manager. As the transfer takes place, the system manager user receives periodic progress updates. On completion of the transfer, the integrity of the software just loaded is checked, with a successful transfer being indicated if the integrity check passes.

### Distributing the New Software to the Subsystems

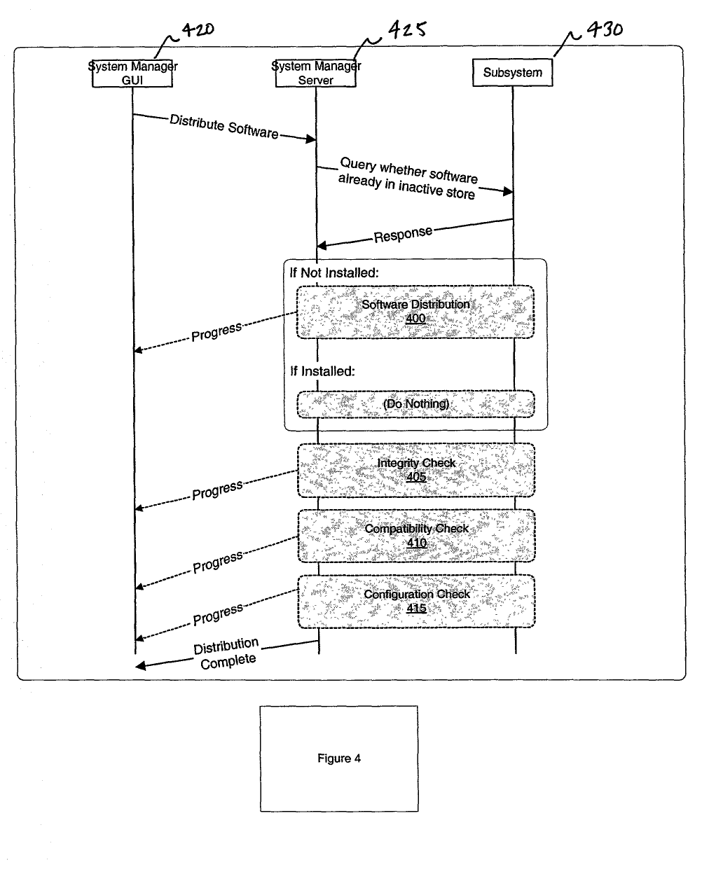

FIG. 4 illustrates how the system manager distributes the software to the various subsystems in an exemplary embodiment. When commanded to distribute software, the system manager sequentially performs the distribution 400 using a standard file transfer protocol and initiates an integrity check 405, a compatibility check 410, and a configuration check 415 on each subsystem to be upgraded.

### Integrity Check

This check assures that the software residing in a non-volatile memory store in the system manager or a subsystem has integrity, e.g., through a CRC check on the file(s) comprising the software load and through identification of the file(s) as actually comprising a software load. The result of the integrity check can be revealed through an attribute associated with the non-volatile memory store being checked. The attribute can identify for example either the bundle name if the integrity check passes, or a null value if it fails. This check may also be invoked independently, for example, as part of a periodic audit of the integrity of non-volatile memory.

### Compatibility Check

This check determines whether the software in a standby volatile memory store in the system manager or a subsystem is compatible with the software in the active volatile memory store and the system manager or subsystem's presently installed hardware components. The result of the check can be revealed through posting/clearing of one or more off-normal conditions. To facilitate correction of incompatibilities prior to upgrade, it is preferred that subsystems log all incompatibilities detected when this check is requested. Incompatibilities can be logged in an alarm log associated with the volatile memory store from which programs are being executed.

### Configuration Check

This check determines whether the system manager or subsystem equipment and facilities are in a state suitable to permit upgrade. For the check to pass, two conditions must be met. First, all equipment in the subsystem must be operating without faults. Second, the state of any major facilities on which the process of upgrade is dependent must be such that upgrade can be completed. Should a configuration check fail, it is incumbent on the subsystem to identify the problem(s) detected. When requested to check its configuration, it is preferred that a subsystem not only check the state equipment and facilities, but also reconfigure itself as necessary in preparation for upgrade, e.g., make all “A”-side components active and all “B”-side components standby.

### Tiering and Chaining the Upgrade of Subsystems and Clusters

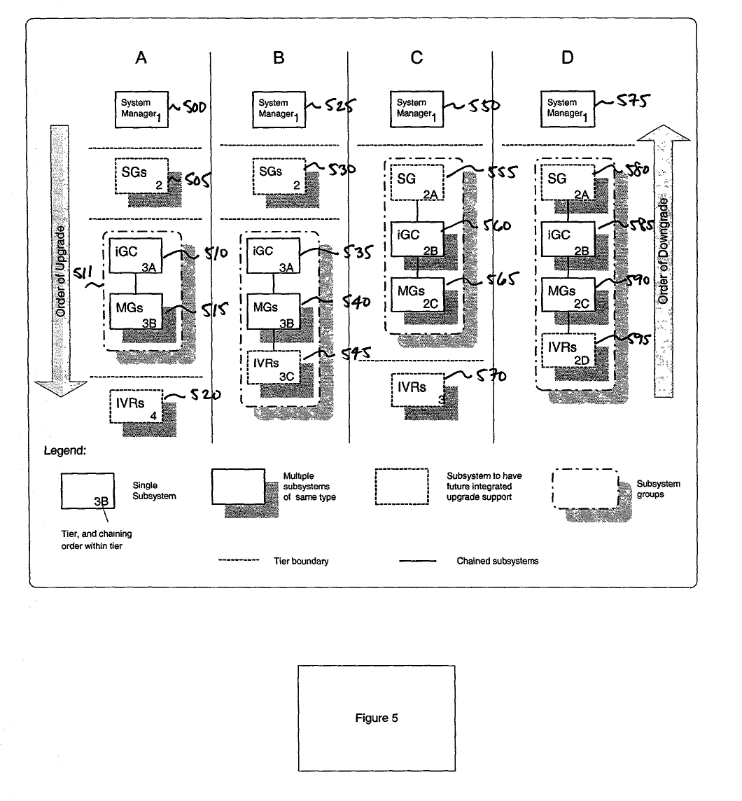

FIG. 5 illustrates exemplary embodiment methods of tiering subsystems for upgrade and chaining subsystem upgrades within groups of subsystems. Possible orderings are suggested in the figure. For example, in one ordering, the system manager 500 is upgraded first and after Committing the system manager to its new software, the subsystems and clusters are upgraded. First, the SGs 505 are upgraded. After Committing the SGs, each cluster 511 of iGCs 510 and MGs 515 are upgraded as a chained group (multiple clusters could be upgrade in parallel, if desired) because the iGCs and MGs are subordinate to the SGs 505. Finally, after Committing each cluster of iGCs and MGs, IVRs 520 are upgraded because the IVRs are subordinate to the iGCs and MGs.

The orderings illustrated in FIG. 5 are not the only ones that can be contemplated, however, and the upgrade process of the present invention is therefore developed to allow for orderings to be changed between releases. While it can generally be anticipated that the subsystems which terminate external control and management interfaces must be upgraded early on, an exemplary embodiment upgrades the system manager first and that the system manager is upgraded alone. Since the program logic that orders upgrade is part of the system manager software, the order of subsystem upgrade for a new software release can be changed as desirable with the upgrade of the system manager.

Note that when upgrading a group of chained subsystems, autonomous reversion of a particular subsystem may cause a loss of service within chained subsystems due to protocol incompatibilities. The system manager is in any case expected to enforce the chaining rule for reversion, since this ensures management control can be exercised over each subsystem and helps preserve service to the extent possible during reversion of subsystems not affected by the failure.

### Dividing, Testing and Committing

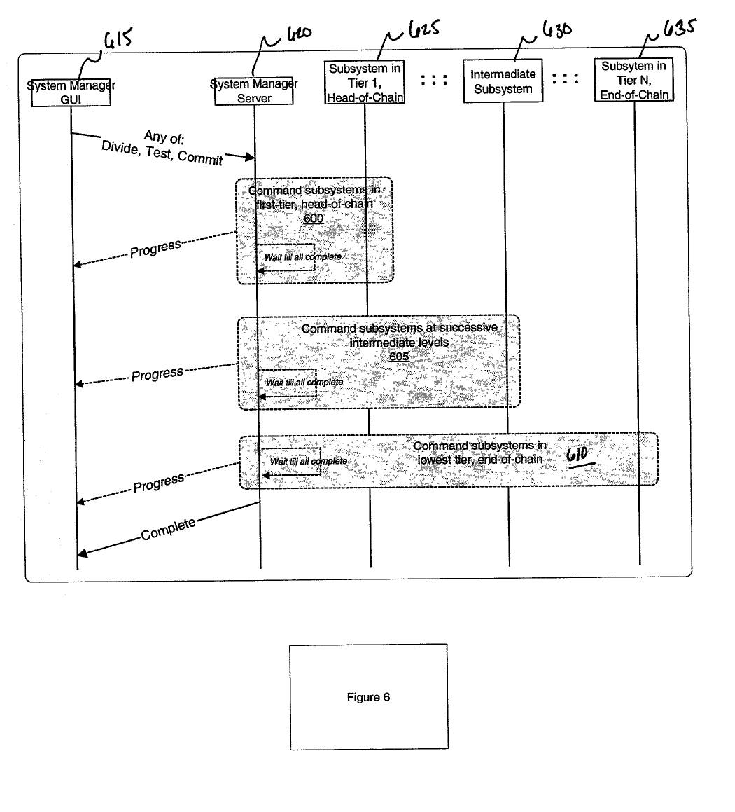

FIG. 6 illustrates the steps of Dividing, Testing, or Committing a subsystem in an exemplary embodiment. The system manager user initiates these steps through a system manager GUI. In processing a command, the system manager accounts for tiering and chaining of subsystems. For example, the system manager initiates an upgrade step on the subsystems in tier 1 at step 600 and waits for the upgrade steps to complete before initiating any further upgrade steps in the intermediate subsystems at step 605. The system manager user receives periodic notifications of the progress of the any of these commands when they are conducted on the subsystems.

### Dividing a Subsystem

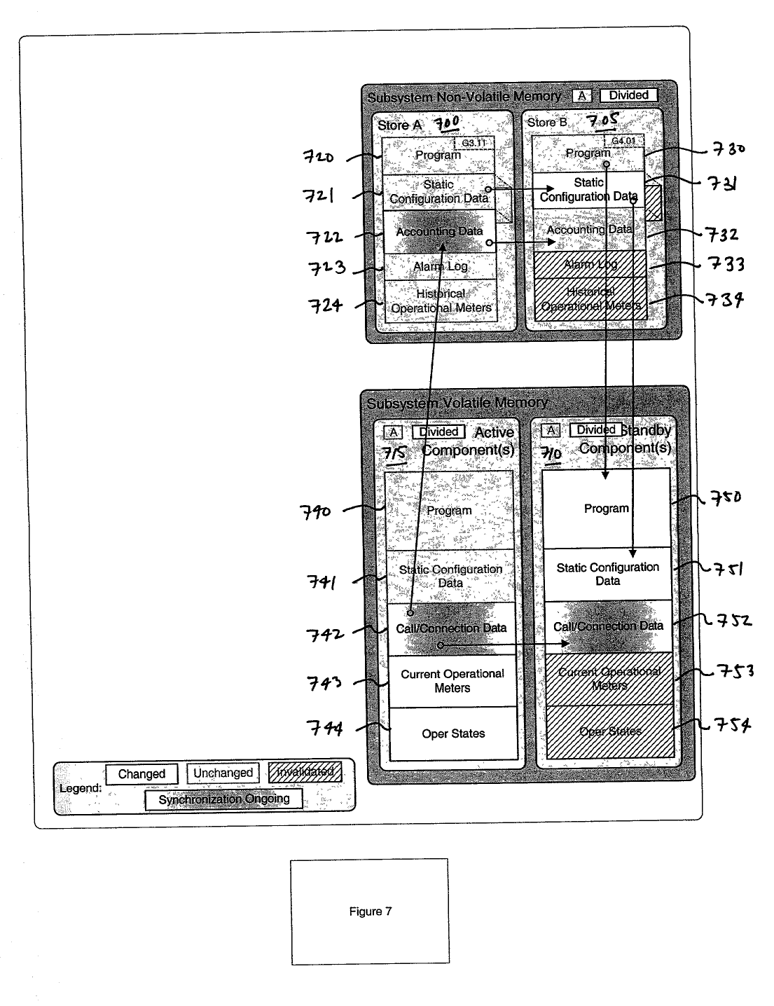

FIG. 7 illustrates Dividing a subsystem in an exemplary embodiment. In a Divide, the standby volatile memory store is upgraded to the new software. The steps of Dividing include: executing integrity, compatibility, and configuration checks on the new software; inhibiting changes to static data on the non-volatile memory store A 700; formatting the static data on non-volatile memory store A 700 to be compatible with the new software, copying the formatted static data from the non-volatile memory store A 700 to the non-volatile memory store B 705; copying the static data from the non-volatile memory store B 705 to the standby volatile memory store 710; copying the new software from the non-volatile memory store B 705 to the standby volatile memory store, restarting the standby equipment with the static data and the new software; synchronizing dynamic data from the active volatile memory store 715 to the standby volatile memory store 710; synchronizing dynamic data from the active volatile memory store 715 to the non-volatile memory store A 700; synchronizing dynamic data from the non-volatile memory store A 700 to the non-volatile memory store B 705. Additionally, alarm conditions expected during the upgrade may be inhibited. Moreover, synchronizing dynamic data from the active volatile memory store 715 to the standby volatile memory store 710 is ongoing throughout the upgrade. Finally, the steps in the Divide need not be executed in the order described. For example, a subsystem might convert all its static data and then re-initialize its components one at a time.

There are many benefits provided by the steps of the Divide. For example, since the dynamic data is continually synchronized throughout the upgrade, if a reversion ever occurs, a subsystem is able to recover valuable accounting data. In addition, in the event of a problem that causes the standby volatile memory 710 (which holds for example the new software and static data formatted to be compatible with the new software) to be lost due to for example power cycling, the non-volatile store B 705 holds a copy of this information to enable a subsystem to retry an upgrade.

### Testing a Subsystem

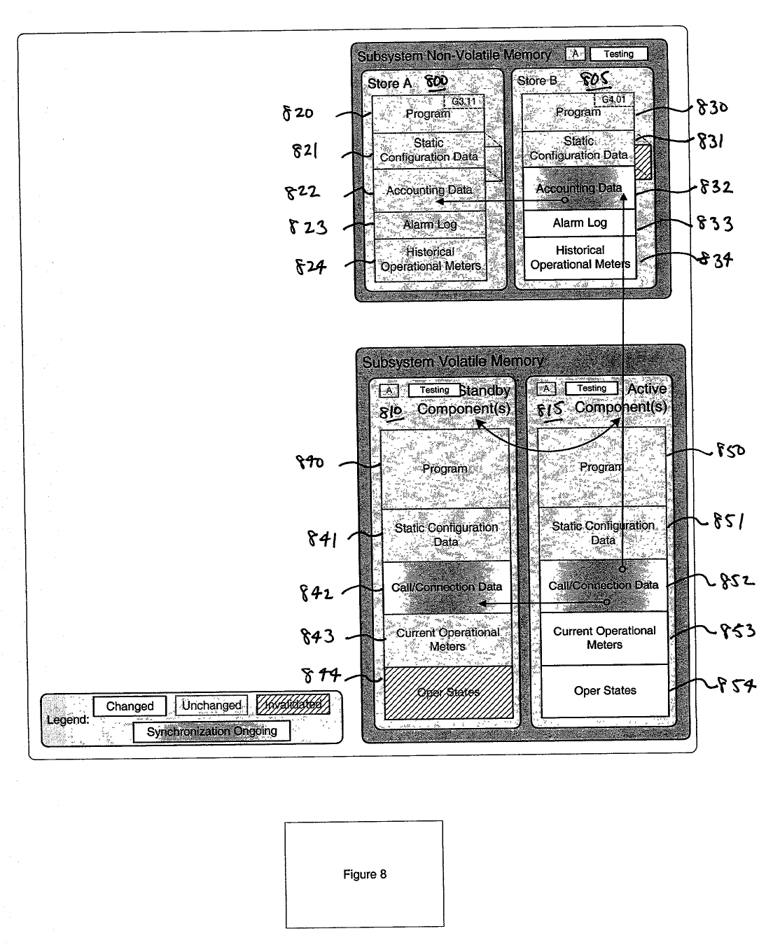

FIG. 8 illustrates Testing a subsystem in an exemplary embodiment. In Testing, the standby components (which were restarted with the new software during the Divide) are “swapped” with the active components. In other words, the standby components are now labeled and recognized by the system as the new active components and the active components are now labeled and recognized by the system as the new standby components. Also, the standby volatile memory is now labeled and recognized by the system as the new active volatile memory and the active volatile memory is now labeled and recognized by the system as the new standby volatile memory. The steps of Testing include: “swapping” active and standby components; purging alarm log, historical and current operational meters; synchronizing dynamic data from the new active volatile memory store 815 to the new standby volatile memory store 810; synchronizing dynamic data from the new active volatile memory store 815 to the non-volatile memory store B 805; synchronizing dynamic data from the non-volatile memory store B 805 to the non-volatile memory store A 800; and allowing changes to static data. Synchronizing dynamic data from the active volatile memory store 815 to the standby volatile memory store 810 is ongoing throughout the upgrade. Alternatively, the step of purging alarm log, historical and current operational meters may be executed before transitioning to the Divide state, particularly if purging significantly extends the influences the duration of service denial in transiting to Testing state.

There are many benefits provided by the steps of the Testing state. For example, because changes to static data are allowed, tests of the new software which require provisioning changes can be executed. By allowing changes to static data in the Testing state, the subsystem can more completely exercise the new software prior to Committing it. Because the alarm log, historical and current operational meters are purged, time is not spent synchronizing then. Current operational meters should not be synchronizes since this information must be determined from the now active equipment. Also, alarm information can be obtained in other ways such as an ongoing alarm audit. For example, since the dynamic data is continually synchronized throughout the upgrade, if a reversion ever occurs, a subsystem is able to recover valuable accounting data. In addition, in the event of a problem that causes the standby volatile memory 810 (which holds for example the new software and static data formatted to be compatible with the new software) to be lost due to for example power cycling, the non-volatile store B 805 holds a copy of this information to enable a subsystem to retry an upgrade.

### Committing a Subsystem

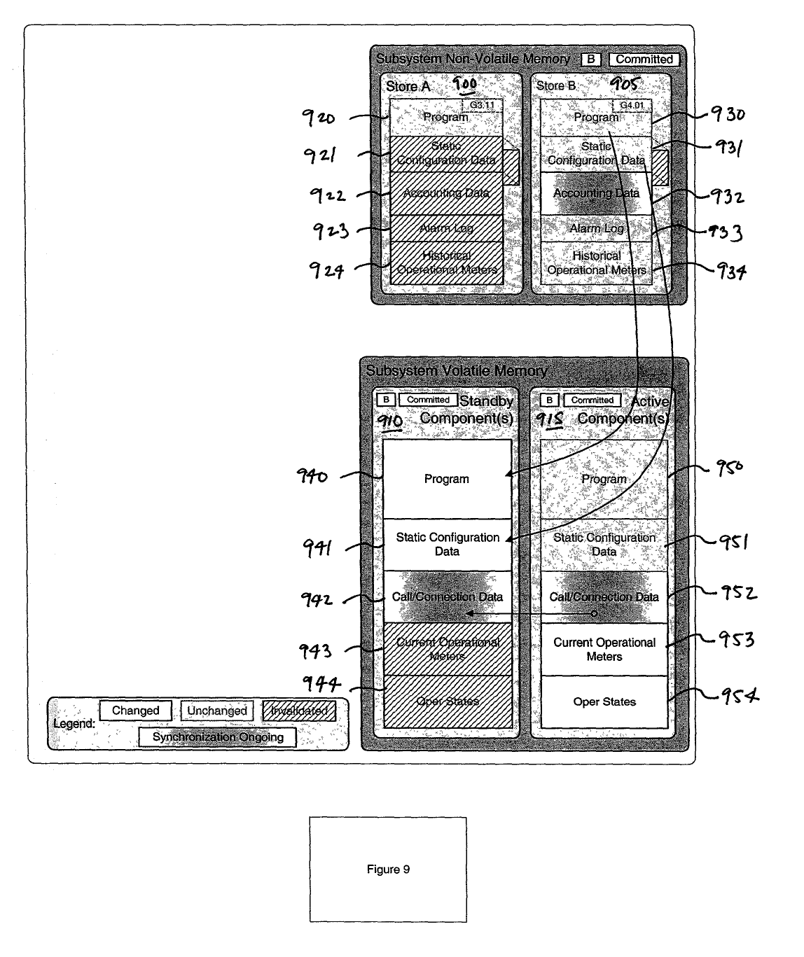

FIG. 9 illustrates Committing a subsystem in an exemplary embodiment. In Committing a subsystem, the new standby volatile memory store (formerly labeled as the active and currently holding the old software) is upgraded to the new software. The steps of Committing include: copying the static data from the non-volatile memory store B 905 to the new standby volatile memory store 910 ; copying the new software from the non-volatile memory store B 905 to the new standby volatile memory store 910; synchronizing dynamic data from the active volatile memory store 915 to the standby volatile memory store 910; and restarting the new standby equipment (formerly labeled as the active equipment) with the static data and the new software.

There are many benefits provided by the steps of the Commit. For example, since the dynamic data is continually synchronized throughout the upgrade, if a reversion ever occurs, a subsystem is able to recover valuable accounting data. In addition, in the event of a problem that causes the standby volatile memory 910 (which holds for example the new software and static data formatted to be compatible with the new software) to be lost due to for example power cycling, the non-volatile store B 905 holds a copy of this information to enable a subsystem to retry an upgrade.

### Commanding a Reversion

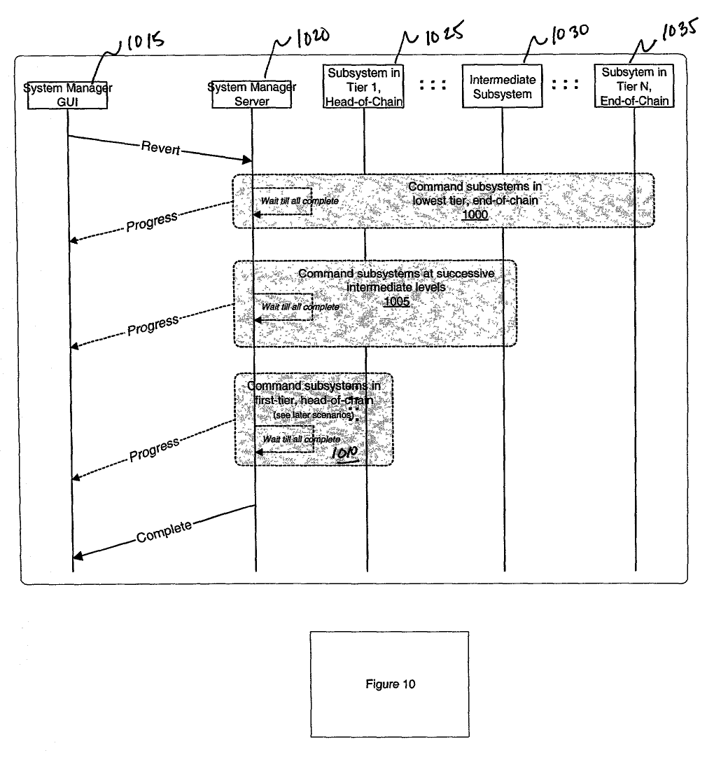

FIG. 10 illustrates chaining and tiering when a reversion of a system of a system is commanded by the system manager user in an exemplary embodiment. The system manager user initiates these steps through a system manager GUI. In processing a command, the system manager accounts for tiering and chaining of subsystems in the opposite order that the upgrade steps of Dividing, Testing, and Committing were executed. For example, the system manager initiates a reversion on the subsystems in the last tier at step 1000 and waits for the reversion to complete before initiating any further reversions in the intermediate subsystems at step 1005. The system manager user receives periodic notifications of the progress of the any of these commands when they are conducted on the subsystems.

### Autonomous Reversion

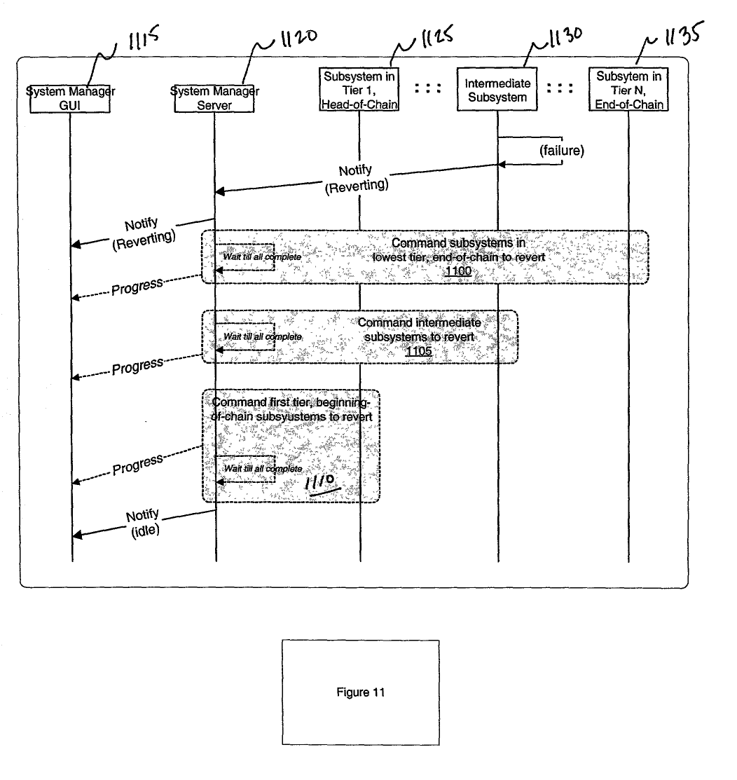

FIG. 11 illustrates chaining and tiering during an autonomous reversion in an exemplary embodiment. When a subsystem autonomously reverts, the system manager triggers an orderly reversion, notifies the system manager user controlling the upgrade that reversion is occurring and notifies the system manager user periodically of the progress of reversion. As in a commanded reversion, the system manager accounts for tiering and chaining of subsystems in the opposite order that the upgrade steps of Dividing, Testing, and Committing were executed. For example, the system manager initiates a reversion on the subsystems in the last tier at step 1100 and waits for the reversion to complete before initiating any further reversions in the intermediate subsystems at step 1105.

### Commanding a Downgrade

In an exemplary embodiment, downgrade is performed in the event of severe problems with a new load that has already been Committed. The system manager user selects subsystems for downgrade in the same manner as they are selected for upgrade. However, selection of subgroups is relaxed to allow multiple tiers to be chosen simultaneously, with the single exception that the system manager must be downgraded by itself last of all. Chaining is not considered during downgrade since the objective is simply to reinitialize whatever group of subsystems is chosen with their old software as quickly as possible.

### Synchronizing Accounting Data

In an exemplary embodiment, in case of reversion, accounting records produced while operating on the new software are available in a billing format for access by a billing collector. A subsystem ensures that all records in any billing file are produced with the same formatting rules and includes versioning information within the each billing file. This approach addresses with the protocol negotiation problem, enabling the billing collector to properly interpret files. When transitioning from old to new software (or vice versa) any records not yet formatted for billing are immediately formatted and added to the billing file currently being produced. The billing file is then closed by the currently operating software, and a new file started by the other software. Records need not otherwise be synchronized between old and new software. In particular, there is no obligation for new software to allow inspection of records produced by old software, or vice versa. A subsystem continuously synchronizes the accounting record areas in the non-volatile stores without regard to the format of the records in individual files.

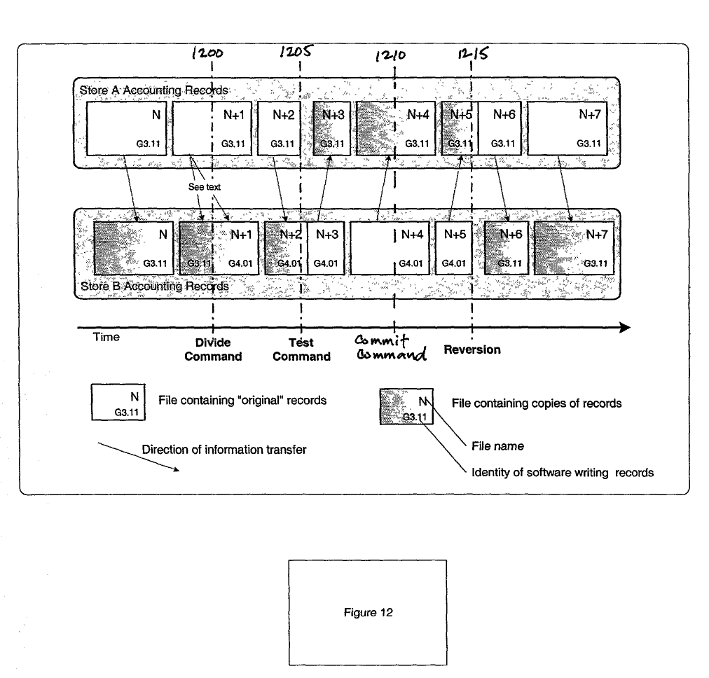

FIG. 12 illustrates synchronization of accounting records during an upgrade in an exemplary embodiment. At step 1200, a Divide command has no effect on the file being actively written at the time Dividing is commanded. At step 1205, a Test command causes the creation of the N+2 file to cease since the software now coming active may produce records in a different format. Therefore, an N+3 file is started as the software comes active. At step 1210, a Commit command has the same effect as a Divide command, except that information flows are reversed. At step 1215, a Revert command causes the creation of the N+5 file to cease. An N+6 file is started once the old software becomes active, since it may be producing records in a different format that was used for the N+5 file.

A more general method to synchronize non-volatile accounting records in an exemplary embodiment is described as follows. A subsystem maintains the version of the records it is producing at any point in time through for example an audit record. Active and standby components of a subsystem exchange billing file names and status changes on an ongoing basis. Each component obtains a copy of closed billing files not directly written to it through for example TFTP. Creation of billing files and formatting of records is driven by the active component on the subsystem. The standby component merely supplements its files with copies of records created by the active component. Whenever an active or standby component makes a state transition, any file currently be written is closed and a new file is started. This allows active and standby components to “catch-up” on records not directly written to their own non-volatile storage.

When commanded to Divide, the standby component must “catch-up” with the active component's billing files after restarting on its new software. On receiving notice that the standby component is operating, the active component closes its current billing file and starts a new one. By doing this, the standby component can immediately begin synchronization with the new file by supplementing its files with copies of records created by the active component and thus avoids the complexity of catching up to a partially filled file.

When commanded to Test, the component transitioning to active status opens a new billing file while the component transitioning to standby status closes its file.

Reversion can be either commanded or autonomous. When commanded, the operation is the same as when commanded to Divide, except that the direction of information transfer is reversed. When autonomous, the general method described above ensures that the newly-active host obtains all available accounting records.

In the foregoing description, the invention is described with reference to specific example embodiments thereof. It will, however, be evident that various modifications and changes may be made thereto, without departing from the broader spirit and scope of the present invention. The specification and drawings are accordingly to be regarded in an illustrative rather than in a restrictive sense.

What is claimed is:

1. A method of managing upgrade steps on a system that includes a subsystem of a first type and a subsystem of a second type that is subordinate to the subsystem of the first type comprising:
initiating an upgrade step on the subsystem of the first type; and
initiating the upgrade step on the subsystem of the second type after completion of the upgrade step on the subsystem of the first type.

2. The method of claim 1 further comprising receiving a completion indication from the subsystem of the first type.

3. The method of claim 1 wherein initiating an upgrade step on the subsystem of the first type comprises sending a command to the subsystem of the first type to execute the upgrade step.

4. The method of claim 1 wherein initiating the upgrade step on the subsystem of the second type comprises sending a command to the subsystem of the second type to execute the upgrade step.

6. The method of claim 1 wherein the upgrade step comprises distributing software to the subsystem.

7. The method of claim 1 wherein the upgrade step comprises testing software on the subsystem.

8. A method for reverting to a prior software after an upgrade to a new software on a system that includes a subsystem of a first type and a subsystem of a second type that is subordinate to the subsystem of the first type comprising:
initiating a reversion on the subsystem of the second type; and
initiating the reversion on the subsystem of the first type after completion of the reversion on the subsystem of the second type.

9. The method of claim 8 further comprising receiving a completion indication from the subsystem of the second type.

10. The method of claim 8 wherein initiating the upgrade step on the subsystem of the second type comprises sending a command to the subsystem of the second type to revert.

11. The method of claim 8 wherein initiating the reversion on the subsystem of the second type comprises sending a command to the subsystem of the second type to revert.

12. A method for managing an upgrade to a new software on a subsystem that includes a first non-volatile memory store, a second non-volatile memory store, an active volatile memory store, a standby volatile memory store, active equipment, standby equipment comprising:
upgrading the standby equipment to the new software;
synchronizing dynamic data from the active volatile memory store to the standby volatile memory store;
synchronizing the dynamic data from the active volatile memory store to the first non-volatile memory store;
synchronizing the dynamic data from the first non-volatile memory store to the second non-volatile memory store;
swapping the standby equipment with the active equipment;
synchronizing dynamic data from the new active volatile memory store to the new standby volatile memory store;
synchronizing the dynamic data from the new active volatile memory store to the second non-volatile memory store;
synchronizing the dynamic data from the second non-volatile memory store to the first non-volatile memory store;
upgrading the new standby equipment to the new software; and
synchronizing dynamic data from the new active volatile memory store to the new standby volatile memory store.

13. The method of claim 12 further comprising
checking if the new software is in an acceptable condition for an upgrade.

14. The method of claim 12 further comprising
checking if the new software and hardware of the subsystem are compatible.

15. The method of claim 12 further comprising
checking if the hardware of the subsystem is in a configuration to accept the software.

16. The method of claim 12 wherein upgrading the standby volatile memory store to the new software comprises:
inhibiting changes to static data on the first non-volatile memory store;
formatting the static data to be compatible with the new software;
copying the static data to the second non-volatile memory store;
copying the static data to the standby volatile memory store;
copying the new software to the standby volatile memory store; and
restarting the standby equipment with the static data and the new software.

17. The method of claim 12 wherein swapping the standby equipment with the active equipment comprises:
labeling the standby equipment as a new active equipment;
labeling the active equipment as a new standby equipment;
labeling the standby volatile memory store as a new active volatile memory store; and
allowing changes to the static data.

18. The method of claim 12 wherein upgrading the new standby volatile memory store to the new software comprises:
copying the static data to the new standby volatile memory store;
copying the new software to the new standby volatile memory store;
restarting the new standby equipment with the static data and the new software; and

19. The method of claim 12 wherein static data comprises provisioning data.

20. The method of claim 12 wherein dynamic data comprises accounting data.
